(19) United States
(12) Patent Application Publication
(10) Pub. No.: US 2026/0178060 A1
(43) Pub. Date: Jun. 25, 2026

(54) IN-VEHICLE DEVICE

(71) Applicant: TOYOTA JIDOSHA KABUSHIKI KAISHA, Toyota-shi (JP)

(72) Inventor: Hiromitsu URANO, Numazu-shi (JP)

(73) Assignee: TOYOTA JIDOSHA KABUSHIKI KAISHA, Toyota-shi (JP)

(21) Appl. No.: 19/402,754

(22) Filed: Nov. 26, 2025

(30) Foreign Application Priority Data
Dec. 23, 2024 (JP) 2024-226615

(51) Int. Cl. G05D 1/85; G01C 21/34; G05D 1/226

(52) U.S. Cl. CPC G05D 1/85; G01C 21/3415; G05D 1/226

(57) ABSTRACT

An in-vehicle device is an in-vehicle device mounted in a vehicle, including a communication unit configured to communicate with a server device via a line for mobile communication, and a controller configured to change a route for autonomously driving the vehicle in response to occurrence of an event of road traffic, and transmit information on the changed route to the server device, in which the controller is configured to maintain, when a communication failure occurs in the line, the route even when the event has occurred.

### CROSS-REFERENCE TO RELATED APPLICATION

This application claims priority to Japanese Patent Application No. 2024-226615 filed on Dec. 23, 2024. The disclosure of the above-identified application, including the specification, drawings, and claims, is incorporated by reference herein in its entirety.

### BACKGROUND

### 1. Technical Field

The present disclosure relates to an in-vehicle device.

### 2. Description of Related Art

A technique of an autonomous driving vehicle that autonomously drives while the vehicle is communicating with an operation management center using a line for communication, such as mobile communication is known. For example, Japanese Unexamined Patent Application Publication No. 2022-024900 (JP 2022-024900 A) discloses an example of an operation management system that causes an autonomous driving vehicle to travel along a target trajectory.

### SUMMARY

In operation management of an autonomous driving vehicle by an operation management center, there is room to improve resistance to a communication failure.

Hereinafter, an in-vehicle device and the like that can improve the resistance to the communication failure in the operation management of the autonomous driving vehicle will be disclosed.

An in-vehicle device according to an embodiment of the present disclosure is an in-vehicle device mounted in a vehicle, including a communication unit configured to communicate with a server device via a line for mobile communication, and a controller configured to change a route for autonomously driving the vehicle in response to occurrence of an event of road traffic, and transmit information on the changed route to the server device, in which the controller is configured to maintain, when a communication failure occurs in the line, the route even when the event has occurred.

With the in-vehicle device and the like according to the present disclosure, it is possible to improve the resistance to the communication failure in the operation management of the autonomous driving vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of an operation management system; and

FIG. 2 is a flowchart showing an operation of the in-vehicle device.

### DETAILED DESCRIPTION OF EMBODIMENTS

Hereinafter, embodiments of the present disclosure will be described.

### Summary of Embodiments

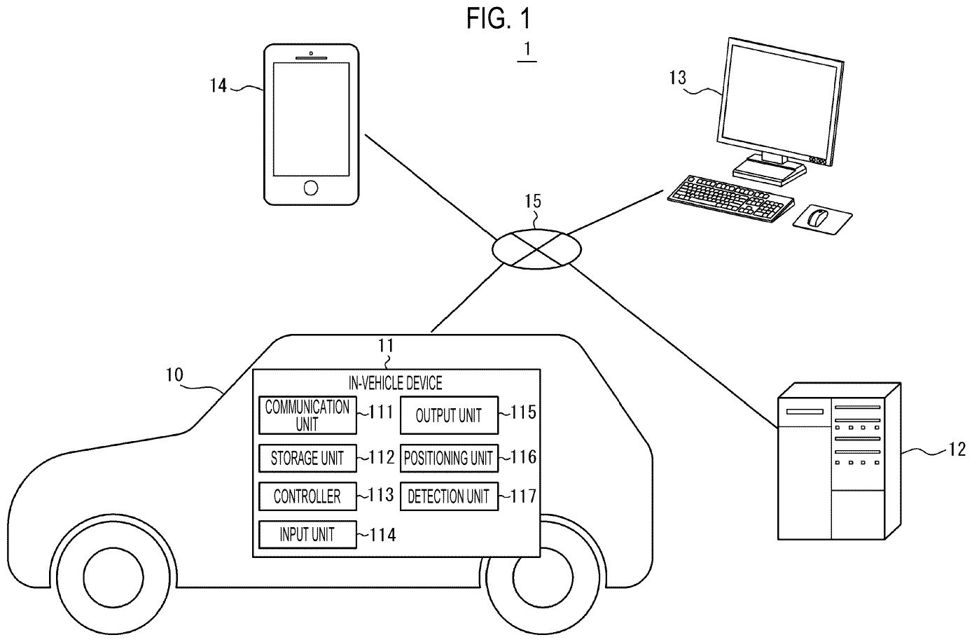

FIG. 1 is a diagram showing an outline of an operation management system according to one embodiment. An operation management system 1 includes an in-vehicle device 11 mounted in each of one or more vehicles 10, one or more server devices 12, one or more operator terminals 13, and one or more user terminals 14. The operation management system 1 is a system that supports the vehicle 10 delivery service. The vehicle 10 is, for example, a passenger car or a commercial vehicle, such as a taxi or a bus. The in-vehicle device 11 is, for example, an information processing apparatus that controls a vehicle, such as an electronic control unit (ECU). The server device 12 is, for example, a server computer that belongs to a cloud computing system or another computing system and that functions as a server implementing various functions. The server device 12 is a center server of a vehicle delivery service provider and performs operation management of the vehicle 10. The operator terminal 13 and the user terminal 14 are, for example, a personal computer or a tablet terminal device. Each of the operator terminal 13 and the user terminal 14 is used by an operator of the vehicle delivery service provider and a user of the vehicle delivery service. A network 15 is, for example, the Internet, an intranet communication network, or a wide area communication network. The in-vehicle device 11, the server device 12, and the operator terminal 13 are connected to each other via the network 15 to be communicable. The server device 12, the operator terminal 13, and the user terminal 14 are connected to each other via the network 15 to be communicable.

In the operation management system 1 according to the present embodiment, the in-vehicle device 11 causes the vehicle 10 to autonomously drive using the autonomous driving function in cooperation with the server device 12. The in-vehicle device 11 transmits information, such as a position of the vehicle 10 and a route on which the vehicle 10 travels to the server device 12. In addition, when an event of road traffic occurs in which the vehicle 10 has difficulty in autonomously driving on a given route, the vehicle 10 may be stacked. In this case, the in-vehicle device 11 communicates with the operator terminal 13 via the server device 12. As a result, the stack is resolved by changing the route in response to a remote instruction from the operator who operates the operator terminal 13 or autonomously changing the route. The in-vehicle device 11 transmits the changed route information to the server device 12. However, when the communication failure occurs in the communication line, the in-vehicle device 11 maintains the route even when an event of road traffic has occurred. Therefore, the information on the route maintained by the vehicle 10 is stored in the server device 12. Therefore, when the vehicle 10 is unable to travel due to any cause when the communication failure occurs in the communication line, the arrival at the destination or the base of the car-hailing service is delayed. As a result, the operator can ascertain the trouble of the vehicle 10 and appropriately dispatch the rescue on the route. Therefore, it is possible to improve the resistance to the communication failure in the operation management of the autonomous driving vehicle.

The event of road traffic is, for example, congestion, an obstacle, an accident, or narrowing or closure of a course due to poor visibility ahead on the route along which the vehicle 10 travels in the traveling direction. The obstacle includes another vehicle that is unable to travel due to an accident and a vehicle that is stopped and loads and unloads cargo. When the vehicle in front does not move for a certain period, for example, for a period of 3 minutes to 5 minutes, the in-vehicle device 11 may determine the vehicle in front as an obstacle. The poor visibility is a case where the in-vehicle camera cannot detect the color of the signal due to an external environment, such as a sunset or thick fog, a case where another vehicle intersecting the course cannot be captured by an obstacle or the like, and the like.

### Configuration of In-Vehicle Device

As shown in FIG. 1, the in-vehicle device 11 includes a communication unit 111, a storage unit 112, a controller 113, an input unit 114, an output unit 115, a positioning unit 116, and a detection unit 117.

The communication unit 111 includes a mobile communication module corresponding to a mobile communication standard, such as long term evolution (LTE), 4th generation (4G), or 5th generation (5G), and a communication module corresponding to a wireless LAN standard. The communication unit 111 is connected to the network 15 and communicates with the server device 12 and the operator terminal 13. In addition, the communication unit 111 can communicate with a road traffic information communication system by using any short-range wireless communication standard (for example, Bluetooth Low Energy (BLE)) and receive traffic information. The communication unit 111 can also transmit and receive various types of information related to an event of road traffic including the traffic information by connecting to the other vehicle 10 using the mobile communication module. The traffic information includes, for example, traffic congestion information, work information, and accident information.

The storage unit 112 includes one or more memories. The memory is, for example, a semiconductor memory, a magnetic memory, or an optical memory. Each memory included in the storage unit 112 functions as, for example, a main memory, an auxiliary memory, or a cache memory. The storage unit 112 stores information used for the operation of the in-vehicle device 11 and information obtained by the operation of the in-vehicle device 11. The information stored in the storage unit 112 may be, for example, information that is updated by being acquired from the network 15 via the communication unit 111. The storage unit 112 stores, for example, a system program for controlling the autonomous driving function, or a route on which the vehicle 10 travels.

The controller 113 includes one or more processors, one or more programmable circuits, one or more dedicated circuits, or a combination thereof. The processor is, for example, a general-purpose processor, such as a central processing unit (CPU) or a graphics processing unit (GPU), or a dedicated processor specialized in specific processing. The programmable circuit is, for example, a field-programmable gate array (FPGA). The dedicated circuit is, for example, an application-specific integrated circuit (ASIC). The controller 113 controls the operation of an entirety of the in-vehicle device 11 while each unit of the in-vehicle device 11 is controlled. The controller 113 determines a route on which the vehicle 10 travels and causes the vehicle 10 to autonomously drive using the autonomous driving function along the determined route.

The input unit 114 includes one or more input devices that receive an operation by an operator. The input device is, for example, a physical key, a capacitive key, a capacitive panel, a touch screen provided integrally with a display, or a microphone that receives voice input. The input unit 114 receives an input of information used for the operation of the controller 113 and transmits the input information to the controller 113. The input unit 114 receives an operation by a passenger of the vehicle 10, for example, when a trouble occurs in the vehicle 10.

The output unit 115 includes one or more output devices that output information. The output device is, for example, a display that outputs information in a video format or a speaker that outputs information in an audio format. The output unit 115 outputs information obtained by the operation of the controller 113.

The positioning unit 116 includes one or more positioning modules. The positioning module is, for example, a global positioning system (GPS), a quasi-zenith satellite system (QZSS), a global navigation satellite system (GLONASS), or Galileo. The positioning unit 116 acquires position information of the vehicle 10 as information used for the autonomous driving of the vehicle 10.

The detection unit 117 includes one or more sensors. The sensor is, for example, an in-vehicle camera, a vehicle speed sensor, an acceleration sensor, a millimeter wave sensor, or an angular velocity sensor. The in-vehicle camera includes, for example, a front camera, a side camera, or a rear camera. In addition, the in-vehicle camera includes an in-vehicle radar or an in-vehicle light detection and ranging (LiDAR). The detection unit 117 observes various events in each part of the vehicle 10, and acquires an observation result as information used for the autonomous driving of the vehicle 10.

### Operation Flow of In-Vehicle Device

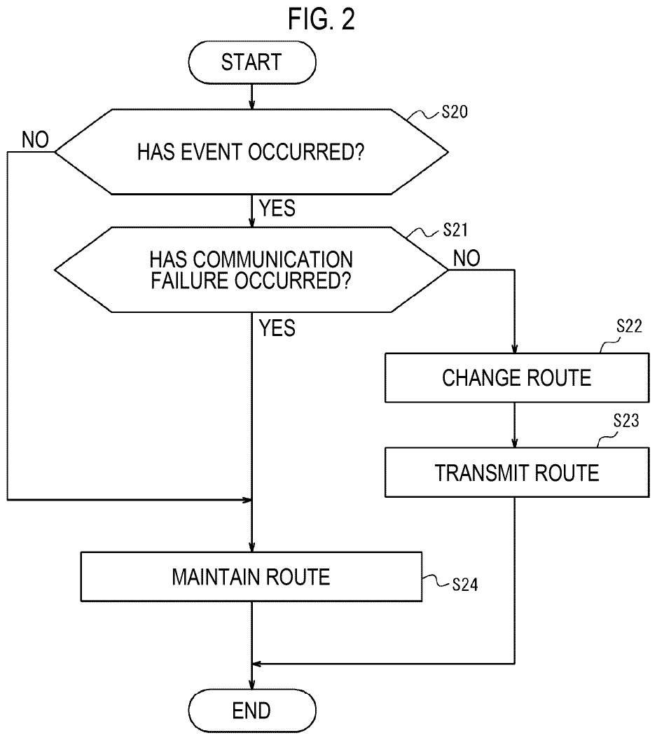

FIG. 2 is a flowchart illustrating an operation example executed by the controller 113 of the in-vehicle device 11. The procedure of FIG. 2 is executed by the controller 113 at any cycle, for example, a cycle of several seconds to several minutes, when the controller 113 determines a route on which the vehicle 10 travels, transmits the determined route to the server device 12, and autonomously drives the vehicle 10 along the route.

In S20, the controller 113 determines whether the event of road traffic has occurred. The controller 113 determines that the event has occurred on the condition that either or both of a congestion and an accident ahead on a route in the traveling direction have occurred, based on, for example, the traffic information received via the communication unit 111. Alternatively, for example, the controller 113 may determine that the event has occurred on the condition that presence or absence of an obstacle ahead or the poor visibility in the forward direction is determined based on the observation result acquired by using the detection unit 117. When the controller 113 determines that the event has occurred (S20—Yes), the controller 113 proceeds to S21. When the controller 113 determines that the event has not occurred (S20—No), the controller 113 proceeds to S24.

In S21, the controller 113 determines whether a communication failure has occurred in the line for mobile communication. The occurrence of the communication failure is, for example, determined on the condition that any one or more of the disconnection of communication, the low speed of communication, and the delay of communication has occurred (hereinafter, referred to as a failure event). The failure event includes a failure or abnormality in hardware or software of a communication-related device. The communication-related device is, for example, a module related to the mobile communication of the in-vehicle device 11, or a module constituting a base station or a center server of a mobile communication operator. The software abnormality in the communication-related device includes, for example, an increase in processing load due to a cyber attack from the outside.

When the controller 113 determines that the failure event has not occurred (S21—No), the controller 113 proceeds to S22. In S22, the controller 113 changes the route. Specifically, the controller 113 re-determines the optimal route based on the traveling route condition, and changes the route on which the vehicle 10 travels to the re-determined route. The traveling route condition includes, for example, a boarding point, a destination, and a priority condition of the traveling route. The traveling route condition is designated or changed by the user who is the user of the dispatch service operating the user terminal 14, for example, at the time of reserving the dispatch service or during the ride. The priority condition includes, for example, the shortest time, the lowest rate, and the low occurrence rate of the stack. In S23, the controller 113 transmits the re-determined route to the server device 12 via the communication unit 111 (hereinafter, the maintained route). As a result, the dispatch service provider or the operator can ascertain the traveling route of the vehicle 10.

When the controller 113 determines that the failure event has occurred (S21—Yes), the controller 113 proceeds to S24. In S24, the controller 113 maintains the maintained route, that is, the current route transmitted to the server device 12, and autonomously drives the vehicle 10. That is, when the failure event occurs, the controller 113 does not change the route including the change of the destination even when the event of road traffic occurs. As a result, even when the server device 12 cannot acquire the position information of the vehicle 10 when the failure event occurs, the vehicle 10 can be found by searching for the vehicle 10 on the maintained route or by following the maintained route. Therefore, the dispatch service can be continuously provided, and it is possible to improve the service quality for the user. It should be noted that even when the failure event occurs, the controller 113 can cause the vehicle 10 to drive autonomously along the maintained route by determining the traveling direction and the position on the traveling route of the vehicle 10 using the positioning unit 116 and the detection unit 117.

The route includes a route connecting the base of the vehicle 10 and the set destination. The base of the vehicle 10 is, for example, a gathering place of the vehicles 10 managed by the dispatch service provider. That is, the vehicle 10 departs from the base, picks up the user at the boarding point, and delivers the user to the destination, and arrives at the base. It should be noted that the base at the time of departure and the base at the time of arrival may not be the same place. The configuration described above makes it possible for the server device 12 to determine that the vehicle 10 has a trouble on the condition that the vehicle 10 does not arrive at the base or the destination even at the scheduled arrival time based on the maintained route. Alternatively, the server device 12 determines that the vehicle 10 has a trouble on the condition that the arrival report is not sent to the server device 12 from the in-vehicle device 11, the user, or the like until a predetermined period elapses from the scheduled arrival time. The predetermined period is, for example, any time, such as 10 minutes to 30 minutes. Alternatively, the server device 12 may predict the position of the vehicle 10 on the maintained route and use the delay in the arrival caused by the congestion or the accident ahead in the traveling direction of the position as the predetermined period. When the server device 12 determines that the vehicle 10 has a trouble, the server device 12 transmits a notification that the vehicle 10 may stop due to the trouble to, for example, the operator terminal 13. The operator terminal 13 can receive an operation of an operator for dispatching the rescue to the maintained route. As described above, by being able to ascertain the maintained route on which the vehicle 10 is traveling, the trouble of the vehicle 10 can be noticed even in a situation in which the server device 12 and the operator terminal 13 cannot communicate due to the occurrence of the failure event. In addition, even when the position information of the vehicle 10 cannot be acquired due to the occurrence of the failure event, the rescue can be dispatched to the maintained route, so that the vehicle 10 can be released from the trouble.

An example of the trouble of the vehicle 10 is a hardware failure or a hang-up of the in-vehicle device 11. Alternatively, another example is a passenger trouble. The passenger trouble is, for example, a trouble in payment of a fare, and includes, for example, occurrence of non-payment due to a shortage of cash of the passenger and a failure of a settlement device mounted in the vehicle 10. Alternatively, another example is a case in which the event of road traffic cannot be autonomously resolved. The rescue dispatched by the operator terminal 13 includes a road service, a technician who performs various repairs on the vehicle 10, a work staff who handles the passenger trouble, and the like.

As a modification, the determination of the occurrence of the event of road traffic in S20 and the determination of the occurrence of the communication failure in S21 may be executed in an order that is reversed.

The present disclosure has been described using an example in which the vehicle 10 is a taxi, but the present disclosure can be applied to any vehicle 10 that autonomously drives along a route to a set destination. Examples of the vehicle 10 include a logistics vehicle that transports a load to a destination and a promotional vehicle that broadcasts an advertisement.

Further, an embodiment is also possible in which the configurations and operations of the in-vehicle device 11 and the server device 12 are distributed to a plurality of computers that can communicate with each other.

Although the present disclosure has been described based on the drawings and embodiment, the person skilled in the art should note that various modifications and changes may be made based on the present disclosure. Therefore, it should be noted that the modifications and changes are within the scope of the present disclosure. For example, functions included in each configuration unit, each step, or the like can be rearranged as long as there is no logical contradiction, and a plurality of configuration units or steps or the like can be combined into one or can be divided.

In addition, for example, an embodiment is also possible in which a general-purpose computer functions as the in-vehicle device 11 according to the embodiment. Specifically, a program that describes processing contents for realizing each function of the in-vehicle device 11 according to the embodiment is stored in a memory of a general-purpose computer, and the processor reads out and executes the program. Therefore, the present disclosure can also be realized as a program that is executable by the processor or a non-transitory computer-readable medium that stores the program.

What is claimed is:

1. An in-vehicle device mounted in a vehicle, comprising:
a communication unit configured to communicate with a server device via a line for mobile communication; and
a controller configured to change, when information indicating occurrence of an event including at least one of congestion, an accident, presence of an obstacle, and poor visibility ahead on a route along which the vehicle travels when the vehicle is autonomously driven is received, the route and transmit information on the changed route to the server device,
wherein the controller is configured to maintain, when determination is made that a communication failure has occurred in the line, the route even when the information indicating the occurrence of the event is received.

2. An in-vehicle device mounted in a vehicle, the in-vehicle device comprising:
a communication unit configured to communicate with a server device via a line for mobile communication; and
a controller configured to change a route for autonomously driving the vehicle in response to occurrence of an event of road traffic, and transmit information on the changed route to the server device,
wherein the controller is configured to maintain, when a communication failure occurs in the line, the route even when the event has occurred.

3. The in-vehicle device according to claim 2, wherein the event is at least one of congestion, an accident, presence of an obstacle, and poor visibility ahead on the route in a traveling direction of the vehicle.

4. The in-vehicle device according to claim 2, wherein the route is a route connecting a base of the vehicle and a set destination.
